(19) United States
(12) Patent Application Publication
(10) Pub. No.: US 2011/0205355 A1
(43) Pub. Date: Aug. 25, 2011

(54) Data Mining Method and System For Estimating Relative 3D Velocity and Acceleration Projection Functions Based on 2D Motions

(75) Inventors: Lipin LIU, Belle Mead, NJ (US); Kuo Chu Lee, Princeton Junction, NJ (US)

(73) Assignee: Panasonic Corporation, Osaka (JP)

(21) Appl. No.: 12/709,046

(22) Filed: Feb. 19, 2010

(51) Int. Cl. H04N 7/18

(52) U.S. Cl. 348/135; 348/E07.085

(57) ABSTRACT

A method for determining a transformation matrix used to transform data from a first image of a space to a second image of the space is disclosed. The method comprises receiving image data from a video camera monitoring the space, wherein the video camera generates image data of an object moving through the space and determining spatio-temporal locations of the object with respect to a field of view of the camera from the image data. The method further comprises determining observed attributes of motion of the object in relation to the field of view of the camera based on the spatio-temporal locations of the object, the observed attributes including at least one of a velocity of the object with respect to the field of view of the camera and an acceleration of the object with respect to the field of view of the camera. The method also includes determining the transformation matrix based on the observed attributes of the motion of the object.

### FIELD

The present disclosure relates to a system and method for determining a transformation matrix to transform a first image into a second image and to transform the first image into the second image.

### BACKGROUND

As the need for video surveillance systems grows, the need for more automated systems is becoming more apparent. These systems are configured to detect moving objects and to analyze the behavior thereof. In order to optimize these systems, it is important for the system to be able to geospatially locate objects in relation to one another and in relation to the space being monitored by the camera.

One solution that has been proposed is to use a calibrated camera, which can provide for object detection and location. These cameras require large amounts of time to manually calibrate the camera, however. Further, the manual calibration of the camera is a very complicated process and requires the use of a physical geometric pattern, such as a checkerboard, lighting pattern, or a landmark reference. As video surveillance cameras are often placed in parking lots, large lobbies or in wide spaces, a field of view (FOV) of camera is often quite large and the calibration objects, e.g. checkerboard, are too small to calibrate the camera in such a large FOV. Thus, there is a need for video surveillance systems having cameras that are easier to calibrate and that improve object location.

This section provides background information related to the present disclosure which is not necessarily prior art.

### SUMMARY

A method for determining a transformation matrix used to transform data from a first image of a space to a second image of the space is disclosed. The method comprises receiving image data from a video camera monitoring the space, wherein the video camera generates image data of an object moving through the space and determining spatio-temporal locations of the object with respect to a field of view of the camera from the image data. The method further comprises determining observed attributes of motion of the object in relation to the field of view of the camera based on the spatio-temporal locations of the object, the observed attributes including at least one of a velocity of the object with respect to the field of view of the camera and an acceleration of the object with respect to the field of view of the camera. The method also includes determining the transformation matrix based on the observed attributes of the motion of the object.

This section provides a general summary of the disclosure, and is not a comprehensive disclosure of its full scope or all of its features.

Further areas of applicability will become apparent from the description provided herein. The description and specific examples in this summary are intended for purposes of illustration only and are not intended to limit the scope of the present disclosure.

### DRAWINGS

FIG. 1 is a block diagram illustrating an exemplary video surveillance system;

FIG. 2 is a block diagram illustrating exemplary components of the surveillance system;

FIG. 3A is a drawing illustrating an exemplary field of view (FOV) of a video camera;

FIG. 3B is a drawing illustrating an exemplary FOV of a camera with a gird overlaid upon the FOV;

FIG. 4 is a drawing illustrating grids of different resolutions and the motion of object with respect to each grid;

FIG. 5 is a block diagram illustrating exemplary components of the data mining module;

FIG. 6 is a drawing illustrating a data cell broken up into direction octants;

FIG. 7 is a block diagram illustrating exemplary components of the processing module;

FIG. 8 is a drawing illustrating motion data with respect to grids having different resolutions;

FIG. 9 is a drawing illustrating an exemplary velocity map having vectors in various directions;

FIG. 10 is a drawing illustrating the exemplary velocity map having only vectors in the dominant flow direction;

FIG. 11 is a drawing illustrating merging of data cells;

FIG. 12 is a flow diagram illustrating an exemplary method for performing data fusion;

FIG. 13 is a drawing illustrating an exemplary grid used for transformation;

FIG. 14 is a flow diagram illustrating an exemplary method for determining a transformation matrix;

FIG. 15 is a block diagram illustrating exemplary components of the calibration module;

FIG. 16 is a drawing illustrating an image being transformed into a second image; and

FIG. 17 is a drawing illustrating an object in the first image being transformed into the second image.

The drawings described herein are for illustrative purposes only of selected embodiments and not all possible implementations, and are not intended to limit the scope of the present disclosure.

Corresponding reference numerals indicate corresponding parts throughout the several views of the drawings.

### DETAILED DESCRIPTION

An automated video surveillance system is herein described. A video camera monitors a space, such as a lobby or a parking lot. The video camera produces image data corresponding to the space observed in the field of view (FOV) of the camera. The system is configured to detect an object observed moving the FOV of the camera, hereinafter referred to as a “motion object.” The image data is processed and the locations of the motion object with respect to the FOV are analyzed. Based on the locations of the motion object, observed motion data, such as velocity and acceleration of the motion object with respect to the FOV can be calculated and interpolated. It is envisioned that this is performed for a plurality of motion objects. Using the observed motion data, a transformation matrix can be determined so that an image of the space can be transformed to a second image. For example, the second image may be a birds-eye-view of the space, i.e. from a perspective above and substantially parallel to the ground of the space. Once the image is transformed into the birds-eye-view, the actual motion data of a motion object, e.g. the velocity and/or acceleration of the motion object with respect to the space, and the geospatial locations of objects in the space can be easily determined with greater precision.

The system can also be configured to be self-calibrating. For example, a computer-generated object, e.g. a 3D avatar, can be inserted into the first image and configured to “move” through the observed space. The image is then transformed. If the 3D avatar in the transformed image is approximately the same size as the 3D avatar in the second image or the observed motion in the second image corresponds to the motion of the first image, then the elements of the translation matrix are determined to be sufficient. If, however, the 3D avatar is much larger or much smaller or the motion does not correspond to the motion observed in the first image, than the elements were incorrect and should be adjusted. The transformation matrix or other parameters are adjusted and the process is repeated.

Once the transformation matrix is properly adjusted, the camera is calibrated. This allows for more effective monitoring of a space. For example, once the space is transformed, the geospatial location of objects can be estimated more accurately. Further, the actual velocity and acceleration, that is with respect to the space, can be determined.

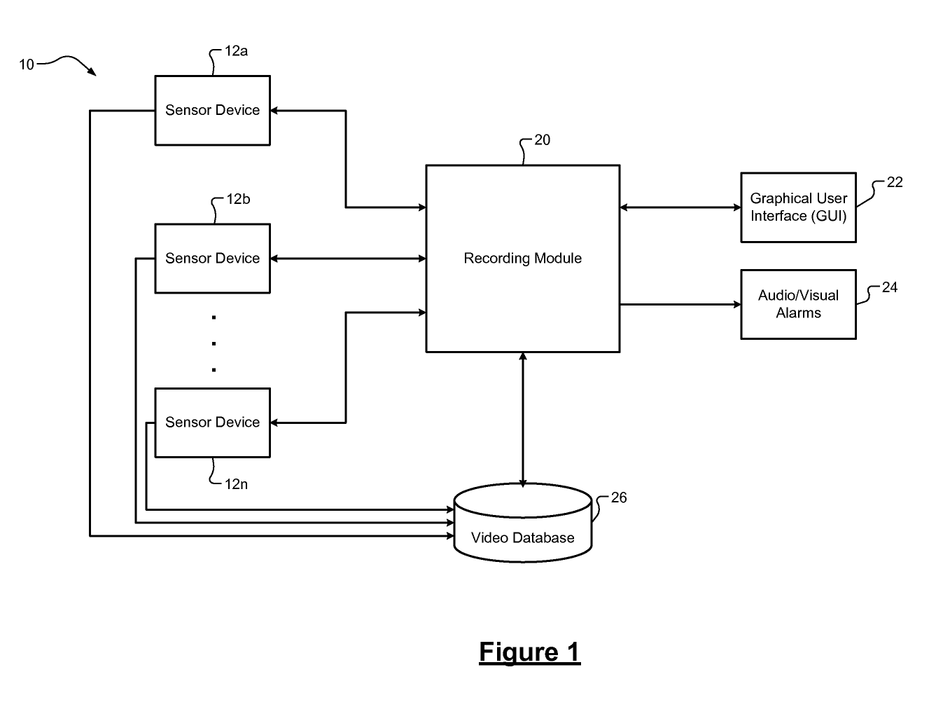

Referring now to FIG. 1, an exemplary video surveillance system 10 is shown. The system may include sensing devices, e.g. video cameras 12a-12n, and a surveillance module 20. It is appreciated that the sensing devices may be other types of surveillance cameras such as infrared cameras or the like. For purposes of explanation, the sensing devices will be herein referred to as video cameras. Further, references to a single camera 12 may be extended to cameras 12a-12n. Video cameras 12a-12n monitor a space and generate image data relating to the field of view (FOV) of the camera and objects observed within the FOV and communicate the image data to surveillance module 20. The surveillance module 20 can be configured to process the image data to determine if a motion event has occurred. A motion event is when a motion object is observed in the FOV of the camera 12a. Once a motion object is detected, an observed trajectory corresponding to the motion of the trajectory of the motion object can be generated by the surveillance module 20. The surveillance module 20 analyzes the behavior or motion of motion objects to determine if abnormal behavior is observed. If the observed trajectory is determined to be abnormal, then an alarm notification can be generated, for example. The surveillance module 20 can also manage a video retention policy, whereby the surveillance module 20 decides which videos should be stored and which videos should be purged from a video data store 26. The video data store 26 can be included in a device, e.g. a recorder, housing the surveillance module 20 or can be a computer readable medium connected to the device via a network.

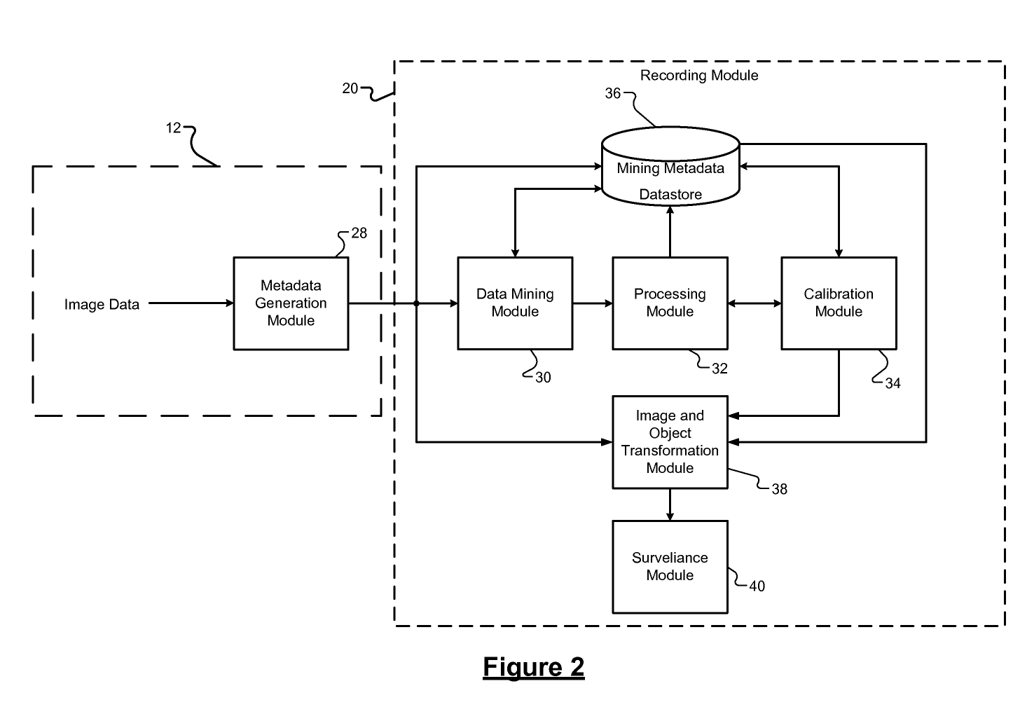

FIG. 2 illustrates exemplary components of the surveillance module 20. The video camera 12 generates image data corresponding to the scene observed in the FOV of the video camera 12. An exemplary video camera 12a includes a metadata generation module 28 that generates metadata corresponding to the image data. It is envisioned that the metadata generation module 28 may be alternatively included in the surveillance module 20. The data mining module 30 receives the metadata and determines the observed trajectory of the motion object. The observed trajectory can include, but is not limited to, the velocities and accelerations of a motion object at various spatio-temporal locations in the FOV of the camera. It is appreciated that the motion data, e.g. the velocities and accelerations, are with respect to the FOV of the camera. Thus, the velocities may be represented in pixels/sec or an equivalent measure of distance with respect to the FOV of the camera per unit of time. It is appreciated that more than one motion object can be observed in the FOV of the camera and, thus, a plurality of observed trajectories may be generated by data mining module 30.

The generated trajectories ultimately may be used to determine the existence of abnormal behavior. In an aspect of this disclosure, however, the trajectories are communicated to a processing module 32. The processing module 32 receives the trajectories and can be configured to generate velocity maps, acceleration maps, and/or occurrence maps corresponding to the motion objects observed in the FOV of the camera. The processing module 32 can be further configured to interpolate additional motion data so that the generated maps are based on richer data sets. The processing module 32 is further configured to determine a transformation matrix to transform an image of the space observed in the FOV into a second image, such as a bird-eye-view of the space. The transformation module 32 uses the observed motion data with respect to the camera to generate the transformation matrix. The transformation matrix can be stored with the various metadata in the mining metadata datastore 36. The mining metadata data store 36 stores various types of data including, metadata, motion data, fused data, transformation matrices, 3d objects, and other types of data used by the recording module 20.

The calibration module 34 calibrates the transformation matrix, thereby optimizing the transformation from the first image to the second image. The calibration module 34 receives the transformation matrix from the processing module 32 or from storage, e.g. the mining data datastore 36. The calibration matrix receives the first image and embeds a computer-generated object into the image. Further, the calibration module 34 can be configured to track a trajectory of the computer-generated object. The calibration module 34 then transforms the image with the embedded computer generated object. The calibration module 34 then evaluates the embedded computer generated object in the transformed space, and the trajectory thereof if the computer generated object was “moved” through the space. The calibration module 34 compares transformed computer generated object with the original computer generated object and determines if the transformation matrix accurately transforms the first image into the second image. This is achieved by comparing the objects themselves and/or the motions of the objects. If the transformation matrix does not accurately transform the image, then the values of the transformation matrix are adjusted by the calibration module 34.

It is envisioned that the surveillance module 20 and its components can be embodied as computer readable instructions embedded in a computer readable medium, such as RAM, ROM, a CD-ROM, a hard disk drive or the like. Further, the instructions are executable by a processor associated with the video surveillance system. Further, some of the components or subcomponents of the surveillance module may be embodied as special purpose hardware.

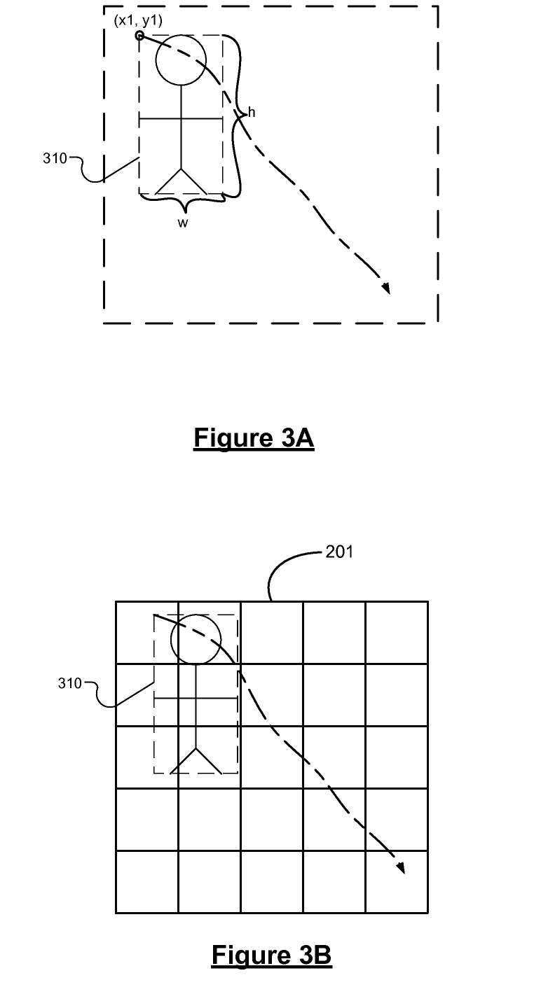

Metadata generation module 28 receives image data and generates metadata corresponding to the image data. Examples of metadata can include but are not limited to: a motion object identifier, a bounding box around the motion object, the (x,y) coordinates of a particular point on the bounding box, e.g. the top left corner or center point, the height and width of the bounding box, and a frame number or time stamp. FIG. 3A depicts an example of a bounding box 310 in a FOV of the camera. As can be seen, the top left corner is used as the reference point or location of the bounding box. Also shown in the figure is examples of metadata that can be extracted, including the (x,y) coordinates, the height and width of the bounding box 310. The trajectory is not necessarily metadata and is shown only to show the path of the motion object. Furthermore, the FOV may be divided into a plurality of cells. FIG. 3B depicts an exemplary FOV divided into a 5×5 grid, i.e. 25 cells. For reference, the bounding box and the motion object are also depicted. When the FOV is divided into a grid, the location of the motion object can be referenced by the cell at which a particular point on the motion object or bounding box is located. Furthermore, the metadata for a time-series of a particular cell or region of the camera can be formatted into a data cube. Additionally, each cell's data cube may contain statistics about observed motion and appearance samples which are obtained from motion objects when they pass through these cells.

As can be appreciated, each time a motion event has been detected, a time stamp or frame number can be used to temporally sequence the motion object. At each event, metadata may be generated for the particular frame or timestamp. Furthermore, the metadata for all of the frames or timestamps can be formatted into an ordered tuple. For example, the following may represent a series of motion events, where the tuple of metadata corresponding to a motion object is formatted according to: <t, x, y, h, w, obj_id>:

<t₁, 5, 5, 4, 2, 1>, <t₂, 4, 4, 4, 2, 1>, . . . <t₅, 1, 1, 4, 2, 1>

As can be seen, the motion object having an id tag of 1, whose bounding box is four units tall and two units wide, moved from point (5,5) to point (1,1) in five samples. As can be seen, a motion object is defined by a set of spatio-temporal coordinates. It is also appreciated that any means of generating metadata from image data now known or later developed may be used by metadata generation module 28 to generate metadata.

Furthermore, the FOV can have a grid overlay divided into a plurality of cells. FIG. 3B depicts an exemplary FOV divided into a 5×5 grid, i.e. 25 cells. For reference, the bounding box and the motion object are also depicted. When the FOV is divided into a grid, the location of the motion object can be referenced by the cell at which a particular point on the motion object or bounding box is located.

Additionally, in an aspect of this disclosure, the metadata generation module 28 can be configured to record the spatio-temporal locations of the motion object with respect to a plurality of grids. As will be shown below, tracking the location of the motion object with respect to a plurality of grids allows the transformation module 32 to perform more accurate interpolation of motion data.

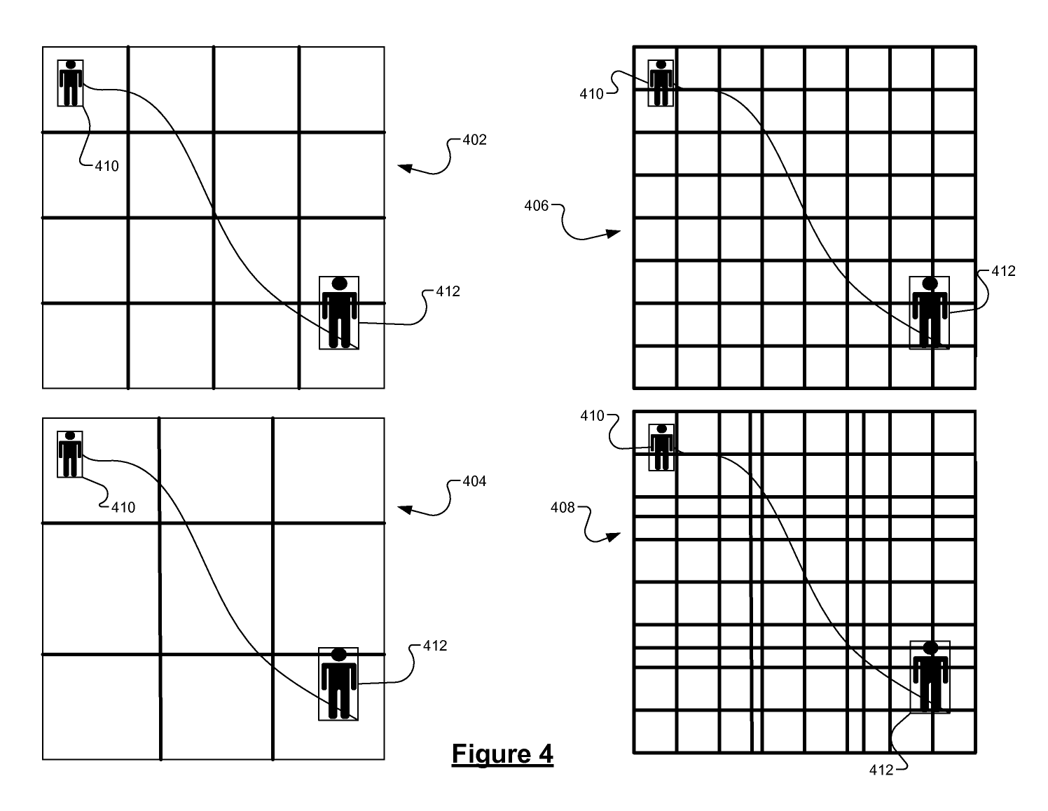

FIG. 4 illustrates an example of multiple grids used to track the motion of an object. As can be seen from the figure, there are three FOVs of the same scene depicted, each with a grid corresponding. FOV 402 has a 4×4 grid, FOV 404 has a 3×3 grid, and FOV 406 has an 8×8 grid. FOV 408 is the view of all three grids overlaid on top of one another. As can be seen in each FOV, the object begins at location 410 and ends at location 412. The metadata generation module 28 tracks the motion of the object by identifying which cell in each grid the object is located at specific times. As can be appreciated in the example of FIG. 4, for each motion event, the metadata generation module 28 can output three cell identifiers corresponding to the location of the object with respect to each grid.

The metadata generation module 28 can also be configured to remove outliers from the metadata. For example if a received metadata for a particular time sample is inconsistent with the remaining metadata then the metadata generation module 28 determines that the sample is an outlier and removes it from the metadata.

The metadata generation module 28 outputs the generated metadata to the metadata mining warehouse 36 and to a data mining module 30. The metadata generation module 28 also communicates the metadata to the transformation module 38, which transforms an image of the space and communicates the transformed image to a surveillance module 40.

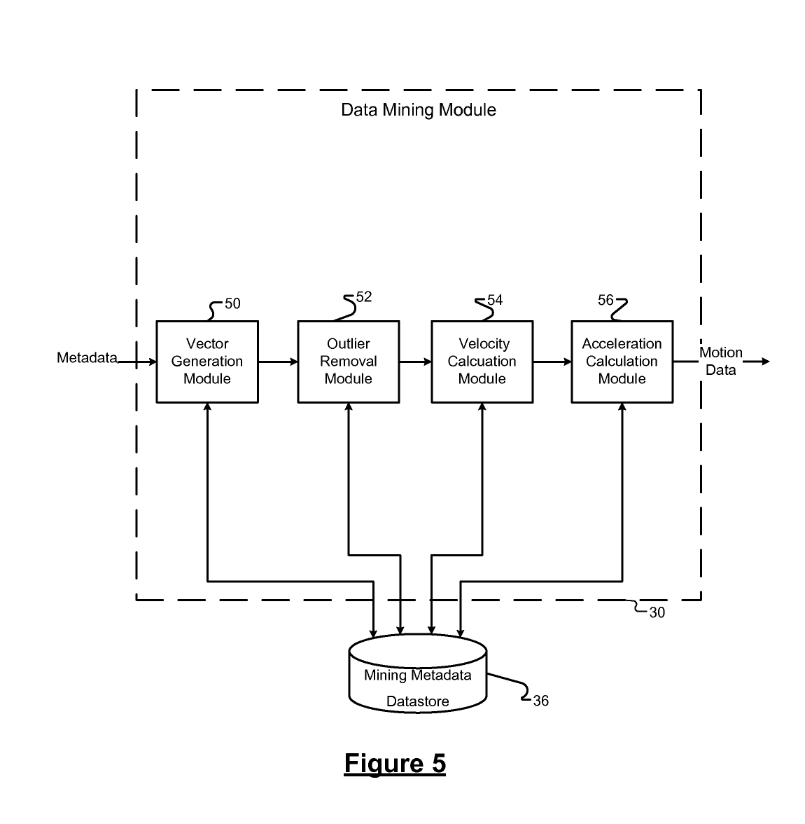

FIG. 5 illustrates exemplary components of the data mining module 30. The data mining module 30 receives the metadata from metadata generation module 28 or from the mining metadata data store 36. The exemplary data mining module 30 comprises a vector generation module 50, a outlier detection module 52, a velocity calculation module 54 and an acceleration calculation module 56.

The vector generation module 50 receives the metadata and determines the amount of vectors to be generated. For example, if two objects are moving in a single scene, then two vectors may be generated. The vector generation module 50 can have a vector buffer that stores up to a predetermined amount of trajectory vectors. Furthermore, the vector generation module 50 can allocate the appropriate amount of memory for each vector corresponding to a motion object, as the amount of entries in the vector will equal the amount of frames or time stamped frames having the motion object detected therein. In the event vector generation is performed in real time, the vector generation module 50 can allocate additional memory for the new points in the trajectory as the new metadata is received. The vector generation module 50 also inserts the position data and time data into the trajectory vector. The position data is determined from the metadata. The position data can be listed in actual (x,y) coordinates or by identifying the cell that the motion object was observed in.

The outlier detection module 66 receives the trajectory vector and reads the values of the motion object at the various time samplings. An outlier is a data sample that is inconsistent with the remainder of the data set. For example, if a motion object is detected at the top left corner of the FOV in samples t1 and t3, but is located in the bottom right corner in sample t2, then the outlier detection module 52 can determine that the time sample for time t2 is an outlier. It is envisioned that any means of detecting outliers may be implemented in outlier detection module. Further, as will be discussed below, if an outlier is detected, the position of the motion object may be interpolated based on the other data samples. It is envisioned that any means of outlier determination can be implemented by the outlier detection module 52.

The velocity calculation module 54 calculates the velocity of the motion object at the various time samples. It is appreciated that the velocity at each time section will have two components, a direction and magnitude of the velocity vector. The magnitude relates to the speed of the motion object. The magnitude of the velocity vector, or speed of the motion object, can be calculated for the trajectory at t_{curr} by:

$$V ( {t}_{curr} ) = \frac{\sqrt{( {( x ( {t}_{cuur} ) - x ( {t}_{cuur - 1} ) )}^{2} + ( {( y ( {t}_{cuur} ) - y ( {t}_{cuur - 1} ) )}^{2}}}{( {t}_{cuur} - {t}_{cuur - 1} )} \qquad ( 1 )$$

Alternatively, the magnitude of the velocity vector may be represented in its individual components, that is:

$$Vx ( {t}_{curr} ) = \frac{( ( x ( {t}_{cuur} ) - x ( {t}_{cuur - 1} ) )}{( {t}_{cuur} - {t}_{cuur - 1} )} and Vy ( {t}_{curr} ) = \frac{( ( y ( {t}_{cuur} ) - y ( {t}_{cuur - 1} ) )}{( {t}_{cuur} - {t}_{cuur - 1} )} \qquad ( 2 )$$

It is further appreciated that if data cell representation is used, i.e. the position of motion object is defined by the data cell which it is found in, a predetermined (x,y) value that corresponds to the data cell or a cell identifier can be substituted for the actual location. Further, if multiple grids are implemented, then the positions and velocities of the motion object can be represented with respect to the multiple grids, i.e. separate representations for each grid. It is appreciated that the calculated velocity will be relative to the FOV of the camera, e.g. pixels per second. Thus, objects further away will appear slower than objects closer to the camera, despite the fact that the two objects may be traveling at the same or similar speeds. It is further envisioned that other means of calculating the relative velocity may be implemented.

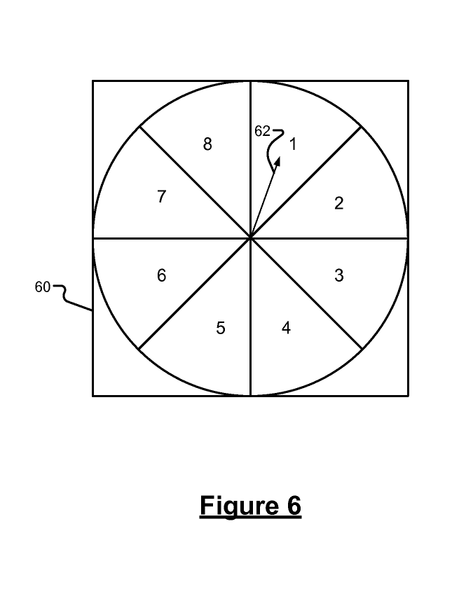

The direction of the velocity vector can be represented relative to its direction in a data cell by dividing each data cell into predetermined sub cells, e.g. 8 octants. FIG. 6 illustrates an example of a data cell 70 broken into 8 octants 1-8. Depending on the direction of the trajectory between the t_{curr} and t_{curr+1} samples, the direction may be approximated by determining which octant the trajectory could fall into. For example, a trajectory traveling in any direction near NNE, e.g. in a substantially upward direction and slightly to the right, can be given a single trajectory direction, as shown by reference 62. Thus, any velocity vector for a data cell may be represented by the data cell octant identifier and magnitude.

The acceleration calculation module 56 operates in substantially the same manner as the velocity calculation module 54. Instead of the position values, the magnitude of the velocity vectors at the various time samples may be used. Thus, the acceleration may be calculated by:

$$A ( {t}_{curr} ) = \frac{\sqrt{( {( Vx ( {t}_{cuur} ) - Vx ( {t}_{cuur - 1} ) )}^{2} + ( {( Vy ( {t}_{cuur} ) - Vy ( {t}_{cuur - 1} ) )}^{2}}}{( {t}_{cuur} - {t}_{cuur - 1} )} \qquad ( 3 )$$

Alternatively, the magnitude of the acceleration vector may be represented in its individual components, that is:

$$Ax ( {t}_{curr} ) = \frac{( ( Vx ( {t}_{cuur} ) - Vx ( {t}_{cuur - 1} ) )}{( {t}_{cuur} - {t}_{cuur - 1} )} and \\ Ay ( {t}_{curr} ) = \frac{( ( Vy ( {t}_{cuur} ) - Vy ( {t}_{cuur - 1} ) )}{( {t}_{cuur} - {t}_{cuur - 1} )} \qquad ( 4 )$$

With respect to the direction, the direction of the acceleration vector may be in the same direction as the velocity vector. It is understood, however, that if the motion object is decelerating or turning, then the direction of the acceleration vector will be different than that of the velocity vector.

The data mining module 30 can be further configured to generate data cubes for each cell. A data cube is a multidimensional array where each element in the array corresponds to a different time. An entry in the data cube may comprise motion data observed in the particular cell at a corresponding time. Thus, in the data cube of a cell, the velocities and accelerations of various motion objects observed over time may recorded. Further, the data cube may contain expected attributes of motion objects, such as the size of the minimum bounding box.

Once the trajectory vector of a motion object is generated, the vector may be stored in the metadata mining warehouse 36.

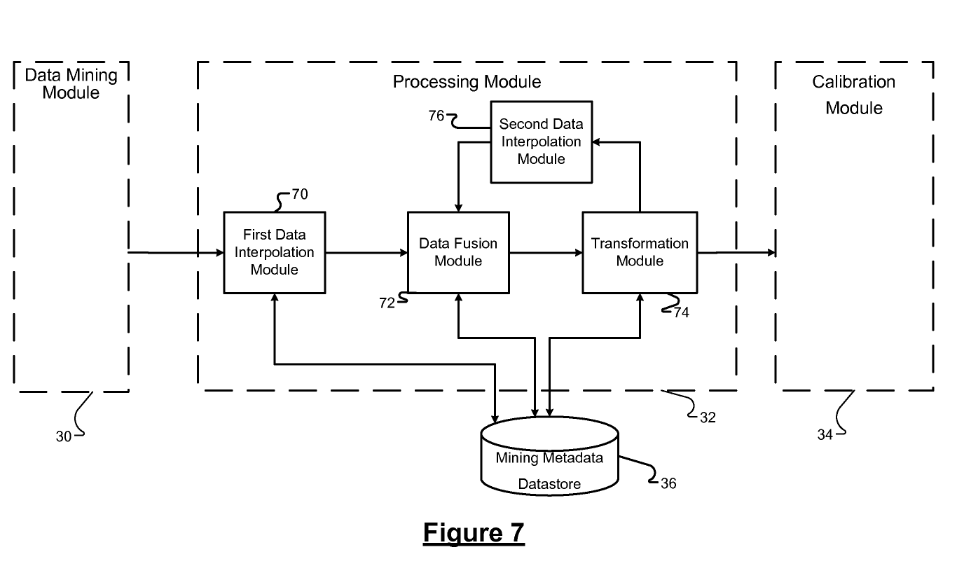

The processing module 32 is configured to determine a transformation matrix to transform an image of the observed space into a second image. FIG. 7 illustrates exemplary components of the processing module 32.

A first data interpolation module 70 is configured to receive a trajectory vector from the data mining module 30 or from the mining metadata data store 36 and to interpolate data for cells having incomplete motion data associated therewith. The interpolated motion data, once determined, is included in the observed motion data for the trajectory.

A data fusion module 72 is configured to receive the observed motion data, including interpolated motion data, and to combine the motion data of a plurality of observed trajectories. The output of the data fusion module 72 may include, but is not limited to, at least one velocity map, at least one acceleration map, and at least one occurrence map, wherein the various maps are defined with respect to the grid by which the motion data is defined.

A transformation module 74 receives the fused data and determines a transformation matrix based thereon. In some embodiments the transformation module 74 relies on certain assumptions such as a constant velocity of a motion object with respect of the space to determine the transformation matrix. The transformation matrix can be used by the surveillance system to “rotate” the view of the space to a second view, e.g. a birds-eye view. The transformation module 74 may be further configured to actually transform an image of the space into a second image. While the first image is referred to as being transformed or rotated, it is appreciated that the transformation can be performed to track motion objects in the transformed space. Thus, when the motion of an object is tracked, it may be tracked in the transformed space instead of the observed space.

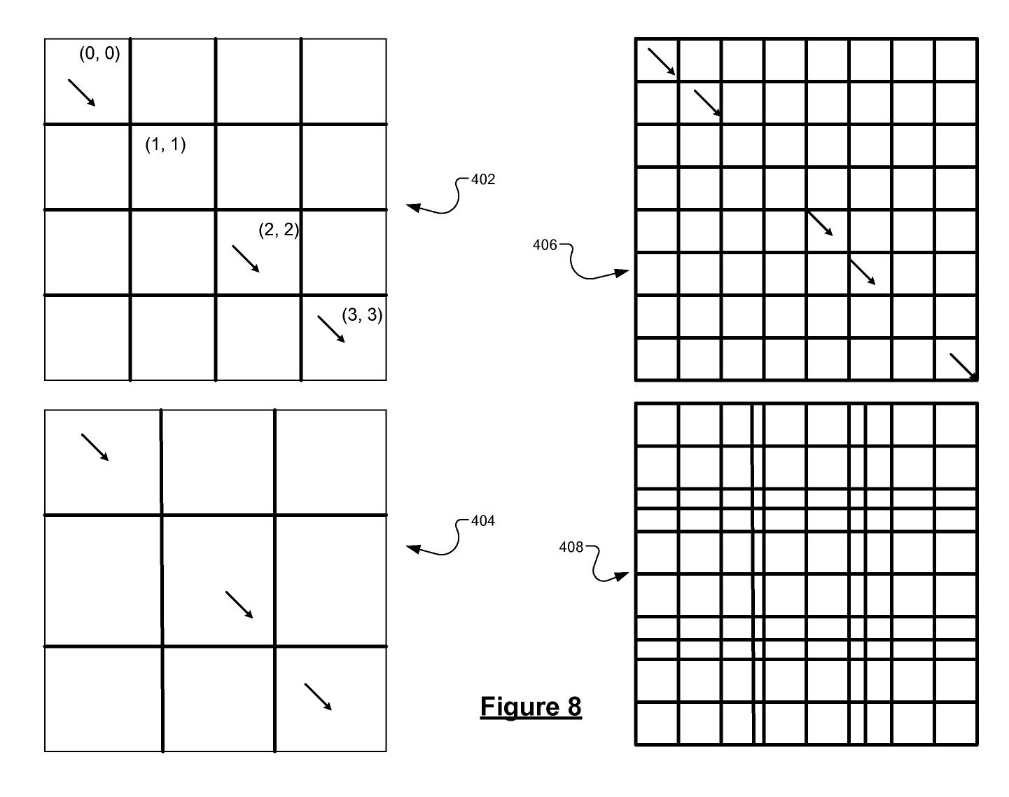

The first data interpolation module 70 can be configured to interpolate data for cells having incomplete data. FIG. 8 illustrates an example of incomplete data sets and interpolation. The FOVs depicted in FIG. 8 correspond to the FOVs depicted in FIG. 4. The arrows in the boxes represent velocity vectors of the motion object shown in FIG. 4.

As can be appreciated, each motion event can correspond to a change from one frame to a second frame. Thus, when motion data is sampled, the observed trajectory is likely composed of samples taken at various points in time. Accordingly, certain cells, which the motion object passed through, may not have data associated with them because no sample was taken at the time the motion object was passing through the particular cell. For example, the data in FOV 402, includes velocity vectors in boxes (0,0), (2,2), and (3,3). To get from box (0,0) to (2,2), however, the trajectory must have passed through column 1. The first data interpolation module 70 is configured to determine which cell to interpolate data for, as well as the magnitude of the vector. It is envisioned that the interpolation performed by the first data interpolation module 70 can be performed by averaging the data from the first proceeding cell and the first following cell to determine the data for the cell having the incomplete data. In alternative embodiments, other statistical techniques such as performing a linear regression on the motion data of the trajectory can be performed to determine the data of the cell having the incomplete data.

The first data interpolation module 70 can be configured to interpolate data using one grid or multiple grids. It is envisioned that other techniques for data interpolation may be used as well

Once the first data interpolation module 70 has interpolated the data, the data fusion module 72 can fuse the data from multiple motion objects. The data fusion module 72 can retrieve the motion data from multiple trajectories from the metadata mining data store 36 or from another source, such as the first data interpolation module 70 or a memory buffer associated thereto. In some embodiments, the data fusion module 72 generates a velocity map indicating the velocities observed in each cell. Similarly, an acceleration map can be generated. Finally, an occurrence map indicating an amount of motion objects observed in a particular cell can be generated. Furthermore, the data fusion module 72 may generate velocity maps, acceleration maps, and/or occurrence maps for each grid. It is appreciated that each map can be configured as a data structure having an entry for each cell, and each entry has a list, array, or other means of indicating the motion data for each cell. For example, a velocity map for a 4×4 grid can consist of a data structure having 16 entries, each entry corresponding to a particular cell. Each entry may be comprised of a list of velocity vectors. Further, the velocity vectors may be broken down into the x and y components of the vector using simple trigonometric equations.

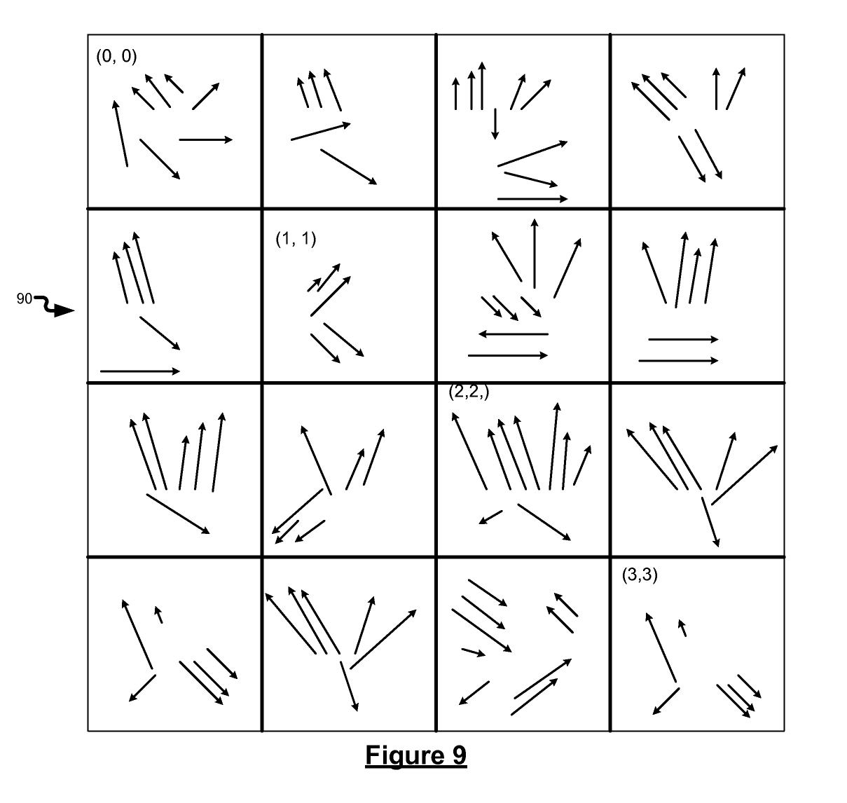

FIG. 9 depicts an exemplary velocity map. As can be seen, the map is comprised of 16 cells. In each cell, the component vectors of trajectories observed in the cell are depicted. As can be seen from the example, the velocity vectors pointing in the up direction have greater magnitude near the bottom of the FOV as opposed to the top. This indicates that the bottom of the FOV corresponds to an area in space that is likely closer to the camera than an area in the space corresponding to the top of the FOV. It is appreciated that the data fusion module 72 may generate an acceleration map that resembles the velocity map, where the arrows would signify the acceleration vectors observed in the cell. An occurrence map can be represented by a cell and a count indicating the number of motion objects observed in the cell during a particular period. The fused data, e.g. the generated maps, can be stored in the mining metadata data store 36.

Further, data fusion module 74 can be further configured to calculate a dominant flow direction for each cell. For each cell, the data fusion module can examine the velocity vectors associated therewith and determine a general flow associated with the cell. This can be achieved by counting the number of velocity vectors in each direction for a particular cell. As described earlier, the directions of vectors can be approximated by dividing a cell into a set of octants, as shown previously in FIG. 6.

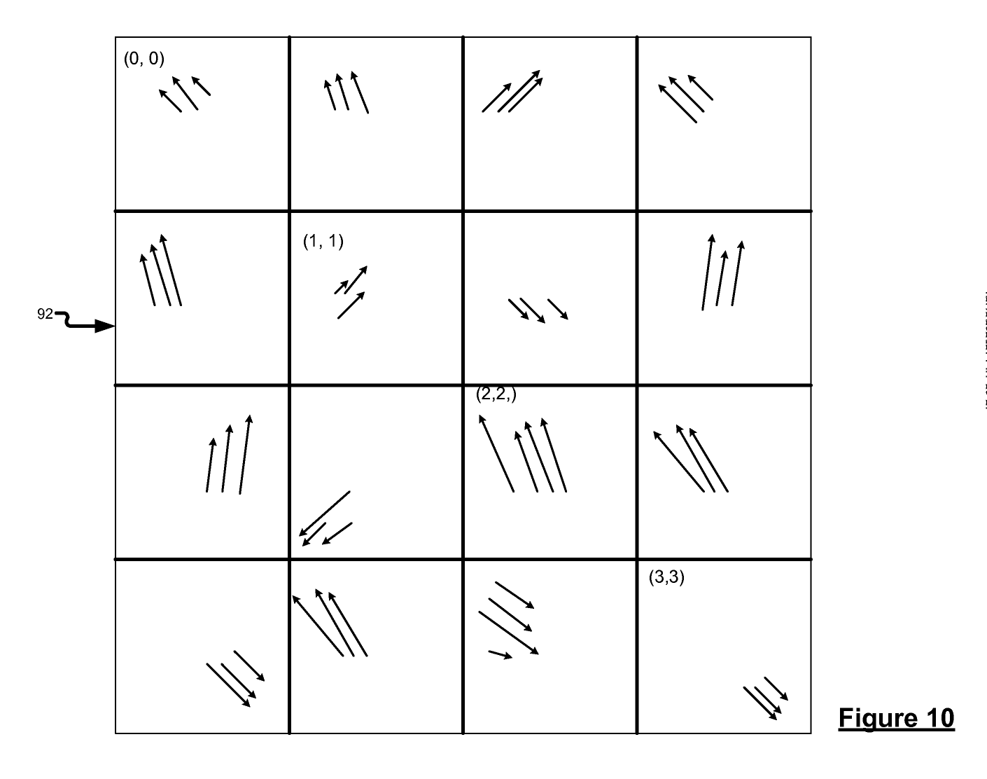

Once the dominant flow direction is determined, the data fusion module 72 removes all of the vectors not in the dominant flow direction of a cell from the velocity map. FIG. 10 corresponds to FIG. 9 and shows a velocity map 102 after the non-dominant flow direction vectors have been removed. In certain embodiments a simplified velocity map having only dominant flow direction vectors is used in the calculations described below to reduce computational complexity of the system. Furthermore, in some embodiments the data fusion module 72 is further configured to determine magnitudes of the dominant flow direction motion vectors, e.g. velocity and acceleration. This can be achieved in various ways, including calculating an average velocity or acceleration in the dominant flow direction. The dominant flow direction vectors can be further broken down into their respective x and y component vectors. For example, the components of the dominant flow direction velocity vector for a particular cell can be calculated by the following:

vx=vm*sin(α); (5)

vy=vm*cos(α); (6)

where vm is the magnitude of the dominant flow direction velocity vector and α is the angle of the direction vector.

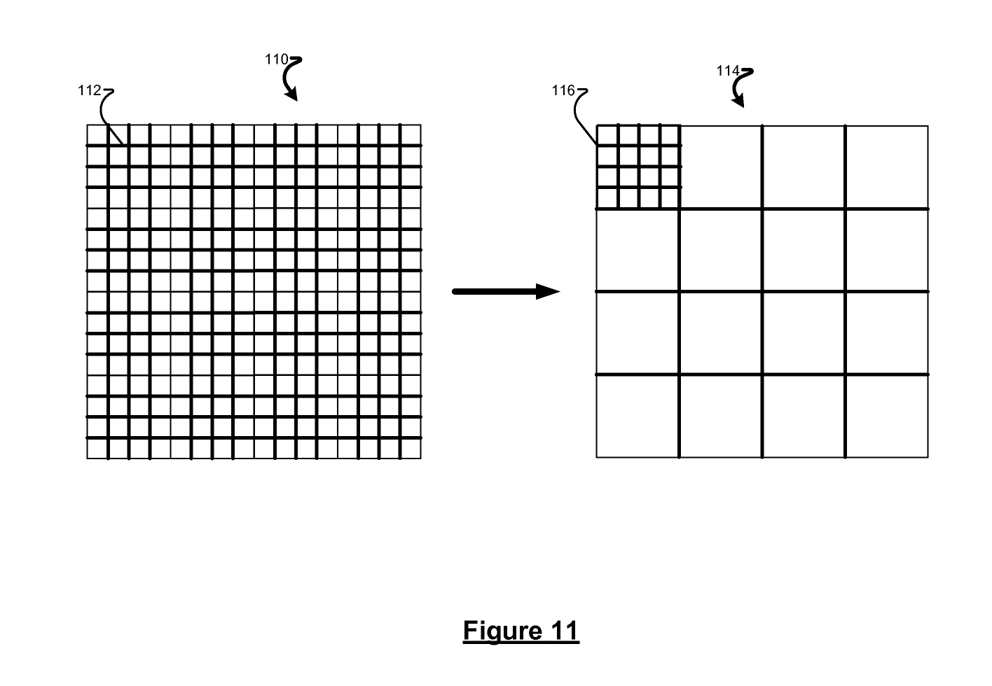

Further, it is appreciated that in some embodiments, if a large number of cells are used, e.g. a 16×16 grid having 256 cells, the data fusion module 72 may merge the cells into larger cells, e.g. a 4×4 grid having 16 cells. It is appreciated that the smaller cells can be simply inserted into the larger cells and treated as a single cell within the larger cell. FIG. 11 illustrates an example of merging data cells. In the figure, grid 110 is a 16×16 grid. Also depicted in the grid 110 is the top left corner sub grid 112, having 16 cells. The data fusion module 72 will insert the data from the top sub grid into the top left cell 116 of grid 114. As can be seen in the figure, the sub grid 112 is merged into the top left cell 116 of grid 114, such that any data from the sub grid 112 is treated as if it is in the single cell 116. The data fusion module 74 performs this operation on the remainder of the cells in the first grid, thereby merging the data from the first grid 112 to the second grid 114. It is appreciated that the grid sizes provided above are for example and are not intended to be limiting. Further, the grids do not need to be square and may be rectangular, e.g. 16×12 merged into a 4×3 grid.

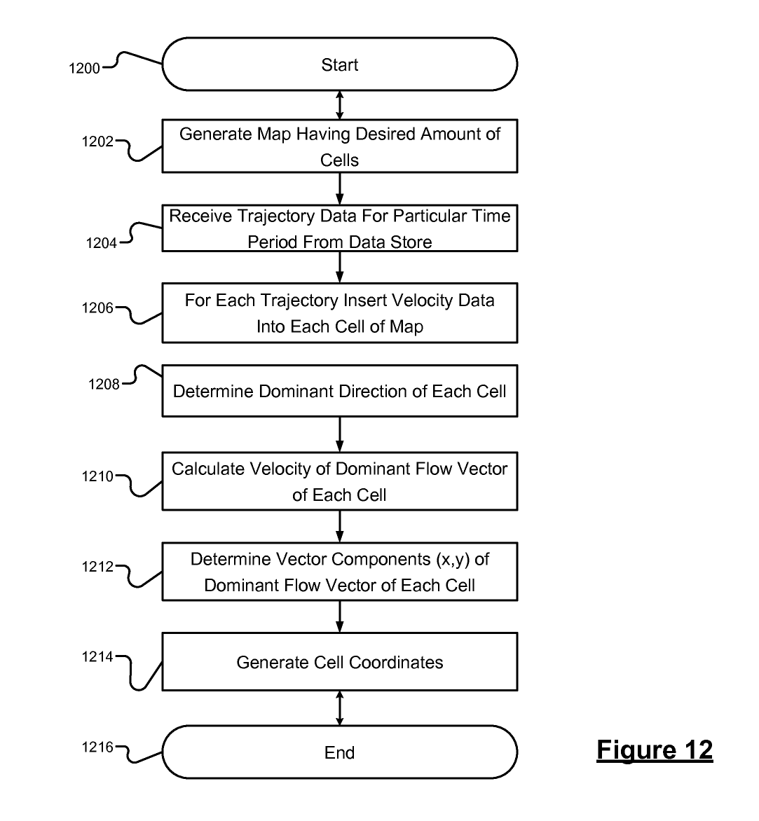

FIG. 12 illustrates an exemplary method that can be performed by data fusion module 72. The data fusion module 72 will generate a motion data map, e.g. a velocity map, having a desired amount of cells, as shown at step 1202. For explanatory purposes, the motion data map is assumed to be velocity map. As mentioned, the velocity data map can be a data structure, such as an array, having entries for each cell of the motion data map.

The data fusion module 72 then retrieves trajectory data for a particular time period from the mining metadata data store 36, as depicted at step 1204. It is appreciated that the system can be configured to analyze trajectories only occurring during a given period of time. Thus, the data fusion module 72 may generate a plurality of velocity maps, each map corresponding to a different time period, the different time periods hereinafter referred to as “slices.” Each map can be identified by its slice, i.e. the time period corresponding to the map.

Once the trajectory data is retrieved, the data fusion module 72 can insert the velocity vectors into the cells of the velocity map, which corresponds to step 1206. Further, if the data fusion module 72 is configured to merge data cells, this may be performed at step 1206 as well. This can be done by mapping the cells used to define the trajectory data to the larger cells of the map, as shown by the example of FIG. 11.

After the data has been inserted into cells of the velocity map, the data fusion module 72 can determine the dominant flow direction of each cell, as shown at step 1208. The data fusion module 72 will analyze each velocity vector in a cell and keep a count for each direction in the cell. The direction having the most velocity vectors corresponding thereto is determined to be the dominant flow direction of the cell.

Once the dominant flow direction is determined, the dominant flow direction velocity vector can be calculated for each cell, as shown in step 1210. As mentioned, this step can be achieved in many ways. For example, an average magnitude of the velocity vectors are directed in the dominant flow direction can be calculated. Alternatively, the median magnitude can be used, or the largest or smallest magnitude can be used as the magnitude of the dominant flow direction velocity vector. Furthermore, the dominant flow direction velocity vector may be broken down into its component vectors, such that it is represented by a vector in the x-direction and a vector in the y-direction, as depicted at step 1212. It is appreciated that the sum of the two vectors equals the dominant flow direction velocity vector, both in direction and magnitude.

The foregoing method is one example of data fusion. It is envisioned that the steps recited are not required to be performed in the given order and may be performed in other orders. Additionally, some of the steps may be performed concurrently. Furthermore, not all of the steps are required and additional steps may be performed. While the foregoing was described with respect to generating a velocity map, it is understood the method can be used to determine an acceleration map as well.

The data fusion module 72 can be further configured to generate an occurrence map. As shown at step 1208, when the directions are being counted, a separate count may be kept for the total amount of vectors observed in each cell. Thus, each cell may have a total amount of occurrences further associated therewith, which can be used as the occurrence map.

Once the data for a particular cell is merged, the data for the particular cell can be represented by the following <cn, rn, vx_{cn,rn}, vy_{cn,rn}, sn>, where cn is the column number of the cell, rn is the row number of the cell, vx_{cn,rn} is the x component of the dominant flow direction velocity vector of the cell, vx_{cn,rn} is the y component of the dominant flow direction velocity vector of the cell, and sn is the slice number. As discussed above, the slice number corresponds to the time period for which the trajectory vectors were retrieved. Furthermore, additional data that may be included is the x and y components of the acceleration vector of the dominant flow direction acceleration vector and the number of occurrences in the cell. For example, the fused data for a particular cell can be further represented by <cn, rn, vx_{cn,rn}, vy_{cn,rn}, ax_{cn,rn}, ay_{cn,rn}, on, sn>.

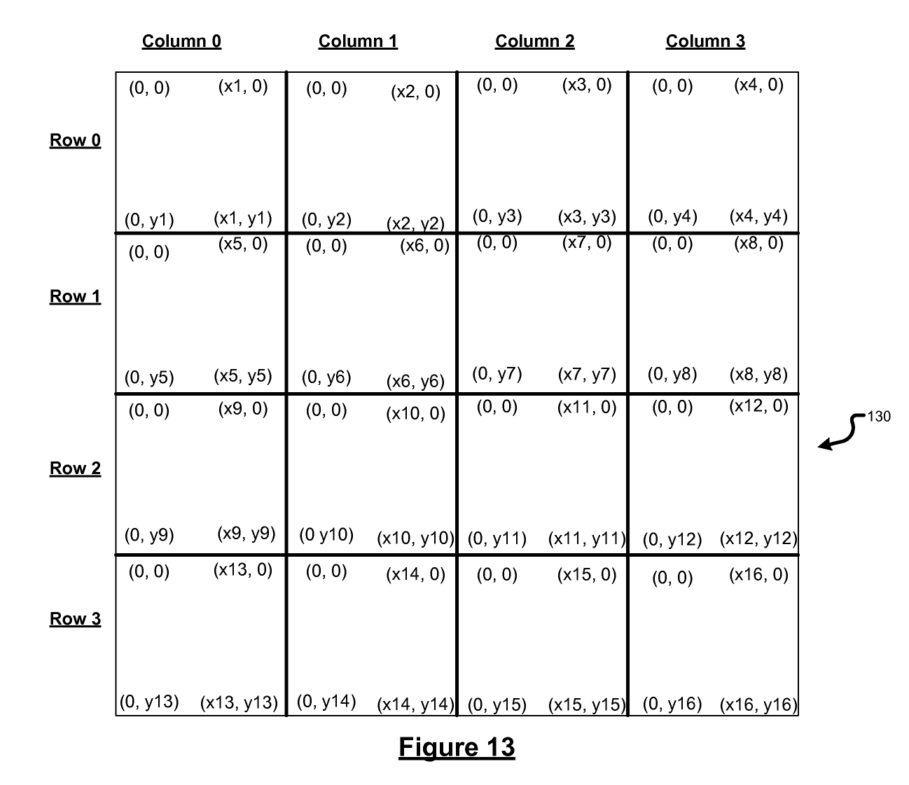

The data fusion module 72 can be further configured to determine four sets of coefficients for each cell, whereby each cell has four coefficients corresponding to the corners of the cell. The data fusion module 72 uses the dominant flow direction velocity vector for a cell to generate the coefficients for that particular cell. FIG. 13 illustrates a 4×4 grid 130 where a set of coefficients for each cell is shown in its corresponding corner. Although the figure shows a grid 120 where the corners of each cell line up at 90 degree angles, it will be apparent that the shape of each cell may be significantly skewed. The vertices or coordinates of each cell can be computed according to the following:

x1=vx_{0,0}

x2=vx_{1,0}

X3=vx_{3,0}

X4=vx_{4,0}

Y1=vy_{0,0}

Y2=vy_{1,0}

Y3=vy_{2,0}

Y4=vy_{3,0}

X5=vx_{0,1}

X6=vx_{1,1}

X7=vx_{2,1}

X8=vx_{3,1}

Y5=vy_{0,1}

Y6=vy_{1,1}

Y7=vy_{2,1}

Y8=vy_{3,1}

X9=vx_{0,2}

X10=vx_{1,2}

X11=vx_{3,2}

X12=vx_{4,2}

Y9=vy_{0,2}

Y10=vy_{1,2}

Y11=vy_{2,2}

Y12=vy_{3,2}

X13=vx_{0,3}

X14=vx_{1,3}

X15=vx_{3,3}

X16=vx_{4,3}

Y10=vy_{0,3}

Y11=vy_{1,3}

Y12=vy_{2,3}

Y13=vy_{3,3}

It is appreciated that vx_{a,b} is the absolute value of the x component of the dominant flow direction velocity vector in the a^{th} column and the b^{th} row and vy_{a,b} is the absolute value of the y component of the dominant flow direction velocity vector in the a^{th} column and the b^{th} row. It is understood that the first column is column 0 and the top row is row 0. Further it is appreciated that the foregoing is an example and the framework described can be used to determine grids of various dimension.

Once the data fusion module 72 has generated the coordinates corresponding to the dominant flow direction of each cell, the transformation module 74 will determine a transformation matrix for each cell. The transformation matrix for a cell is used to transform an image of the observed space, i.e. the image corresponding to the space observed in the FOV of the camera, to a second image, corresponding to a different perspective of the space.

The data fusion module 72 may be further configured to determine actual motion data of the motion objects. That is, from the observed motion data the data fusion module 72 can determine the actual velocity or acceleration of the object with respect to the space. Further, the data fusion module 32 may be configured to determine an angle of the camera, e.g. pan and/or tilt of the camera, based on the observed motion data and/or the actual motion data.

In the present embodiment, the transformation module 74 receives the fused data, including the dominant flow direction of the cell, and the coordinates corresponding to the dominant flow direction velocities of the cell. The transformation module 74 then calculates theoretical coordinates for the cell. The theoretical coordinates for a cell are based on an assumed velocity of an average motion object and the dominant flow direction of the cell. For example, if the camera is monitoring a sidewalk, the assumed velocity will correspond to the velocity of the average walker, e.g. 1.8 m/s. If the camera is monitoring a parking lot, the assumed velocity can correspond to an average velocity of a vehicle in a parking lot situation, e.g. 15 mph or 7.7 m/s.

It is appreciated that the average velocity can be hard coded or can be adaptively adjusted throughout the use of the surveillance system. Furthermore, object detection techniques can be implemented to ensure that the trajectories used for calibration all correspond to the same object type.

The transformation module 74 will use the dominant flow direction of the cell and the assumed velocity, va, to determine the absolute values of the x component and y component of the assumed velocity. Assuming the angle of the dominant flow direction, α, is taken with respect to the x axis, then the x and y components can be solved using the following:

vx′=va*sin(α); (7)

vy′=va*cos(α); (8)

where va is the assumed velocity and α is the angle of the dominant flow direction of the cell with respect to the x-axis (or any horizontal axis). Once the component vectors are calculated, the theoretical coordinates can be inserted into a matrix B′ such that:

$${B}^{′} = \vert \begin{matrix}( 0 , 0 ) & ( {vx}^{′} , 0 ) \\ ( 0 , {vy}^{′} ) & ( {vx}^{′} , {vy}^{′} )\end{matrix} \vert \qquad ( 9 )$$

Also, the calculated coordinates of the cell, i.e. the coordinates of the cell that were based upon the dominant flow direction velocity vector of the cell may be inserted into a matrix B such that:

$$B = \vert \begin{matrix}( 0 , 0 ) & ( vx , 0 ) \\ ( 0 , vy ) & ( vx , vy )\end{matrix} \vert \qquad ( 10 )$$

Using the two matrices, B and B′, the transformation matrix for the cell, A can be solved for. It is appreciated that the transformation matrix A can be defined as follows:

$$A = \vert \begin{matrix}{C}_{00} & {C}_{01} & {C}_{02} \\ {C}_{10} & {C}_{11} & {C}_{12} \\ {C}_{02} & {C}_{12} & {C}_{22}\end{matrix} \vert \qquad ( 11 )$$

The values of A can be solved for using the following:

$$\begin{matrix}{x}_{i}^{′} = ( \frac{{C}_{00} {x}_{i} + {C}_{01} {y}_{i} + {C}_{02}}{{C}_{20} {x}_{i} + {C}_{21} {y}_{i} + {C}_{22}} ) & ( 12 ) \\ {y}_{i}^{′} = ( \frac{{C}_{10} {x}_{i} + {C}_{11} {y}_{i} + {C}_{12}}{{C}_{20} {x}_{i} + {C}_{21} {y}_{i} + {C}_{22}} ) & ( 13 )\end{matrix}$$

where xᵢ′ and yᵢ′ are the coordinate values at the ith element of B′ and xᵢ and yᵢ are the ith element of B, and where i=[1, 2, 3, 4] such that 1 is the top left element, 2 is the top right element, 3 is the bottom right element and 4 is the bottom right element. A system of equations may be utilized to solve for the elements of the transformation matrix A.

The transformation module 74 performs the foregoing for each cell using the fused data for each particular cell to determine the transformation matrix of that cell. Thus, in the example where a 4×4 grid is used, then 16 individual transformation matrices will be generated. Further, the transformation module 74 can store the transformation matrices corresponding to each cell in the mining metadata data store 36.

In an alternative embodiment, the transformation module 74 determines a single transformation matrix to transform the entire image. In the alternative embodiment, the transformation module 74 receives the dominant flow direction velocity vectors and/or acceleration vectors, and the occurrence map.

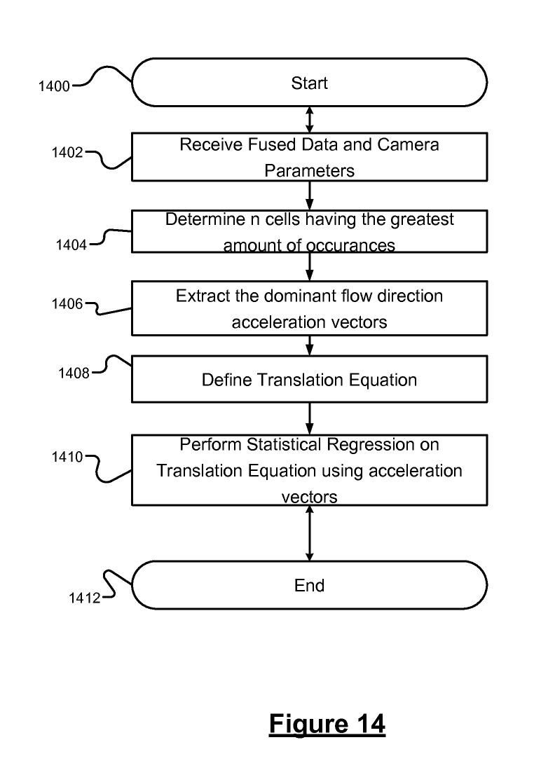

FIG. 14 illustrates an exemplary method that may be performed by the transformation module 74 to determine a single transformation matrix. The transformation module 74 receives the fused data and camera parameters at step 1402. The camera parameters are parameters specific to the camera and may be obtained from the camera manufacturer or a specification from the camera. The camera parameters include a focal length of the camera lens and a central point of the camera. The central point of the camera is the location in an image where the optical axis of the lens would intersect with the image. It is appreciated that this value has an x value, pₓ and a y value p_{y}. The focal length of the lens can also be broken down into its x and y components such that fₓ is the x component of the focal length and f_{y} is the y component of the focal length.

The transformation module 74 will then determine the n cells having the greatest amount of occurrences from the occurrence map, as shown at step 1404. The occurrence map is received with the fused motion data. As will become apparent, n should be greater than or equal to 6. As will also be appreciated, the larger n is the more accurate the transformation matrix will be, but at the cost of computational resources. For each of the n cells, the transformation module 74 will retrieve the x and y component vectors of the dominant flow direction acceleration vector for the particular cell, as shown at step 1406.

Using the camera parameters and the component vectors for the n cells, the translation module 74 will define the translation equation as follows:

$$λ [ \begin{matrix}{a}_{x} \\ {a}_{y} \\ 1\end{matrix} ] = [ \begin{matrix}{f}_{x} & 0 & {p}_{x} \\ & {f}_{y} & {p}_{y} \\ & & 1\end{matrix} ] [ \begin{matrix}1 & 0 & 0 & 0 \\ 0 & 1 & 0 & 0 \\ 0 & 0 & 1 & 0\end{matrix} ] [ \begin{matrix}{R}_{11} & {R}_{12} & {R}_{13} & {t}_{1} \\ {R}_{21} & {R}_{22} & {R}_{23} & {t}_{2} \\ {R}_{31} & {R}_{32} & {R}_{33} & {t}_{2} \\ 0 & 0 & 0 & 1\end{matrix} ] [ \begin{matrix}X \\ Y \\ Z \\ 1\end{matrix} ] \qquad ( 14 )$$

where λ is initially set to 1 and where X, Y, and Z are set to 0. X, Y, and Z correspond to the actual accelerations of the motion objects with respect to the space. It is assumed that when the camera is calibrated, motion objects having constant velocities can be used to calibrate the camera. Thus, the actual accelerations with respect to the space will have accelerations of 0. As can be appreciated, the observed accelerations are with respect to the FOV of the camera, and may have values other than 0. Further, where there are k samples of velocities, there will be k−1 samples of acceleration.

Using a statistical regression, the values of

$$[ \begin{matrix}{R}_{11} & {R}_{12} & {R}_{13} & {t}_{1} \\ {R}_{21} & {R}_{22} & {R}_{23} & {t}_{2} \\ {R}_{31} & {R}_{32} & {R}_{33} & {t}_{2} \\ 0 & 0 & 0 & 1\end{matrix} ] \qquad ( 15 )$$

can be estimated, using the acceleration component vectors of the dominant flow direction accelerations of the n cells as input. It is appreciated that a linear regression can be used as well as other statistical regression and estimation techniques, such as a least squares regression. The result of the regression is the translation matrix, which can be used to transform an image of the observed space into a second image, or can be used to transform an object observed in one space to the second space.

The transformation module 72 can be further configured to determine if the transformation matrix did not receive enough data for a particular region of the FOV. For example, if the regression performed on equation 14 is not producing converging results, the transformation module 72 determines that additional data is needed. Similarly, if the if the results from equation 14 for the different cells are inconsistent, then the transformation module 72 may determine that additional data is needed for the cells. In this instance, transformation matrix will initiate a second data interpolation module 74.

The second data interpolation module 74 receives a velocity map that produced the non-conforming transformation matrices and is configured to increase the amount of data for a cell. This is achieved by either increasing the resolution of the grids and/or by adding data from other slices. For example, referring to FIG. 9, the second data interpolation module 74 can take the 4×4 grid and combine the data into a 2×2 grid, or an 8×8 grid can be combined into the 4×4 grid. The second data interpolation module 74 can also retrieve velocity maps corresponding to other time slices and combines the data from the two or more velocity maps. While velocity maps may correspond to consecutive time slices, the combined velocity maps do not need to correspond to consecutive time slices. For example, velocity maps having similar dominant flow direction patterns can be combined. The results of the second data interpolation module 74 can be communicated to the data fusion module 70.

While the transformation matrices in either embodiment described above are generated by making assumptions about the motion attributes of the motion objects, actual velocities and/or accelerations of motion objects can also be used to determine the transformation matrices. This data can either be determined in a training phase or may be determined by the data fusion module 72.

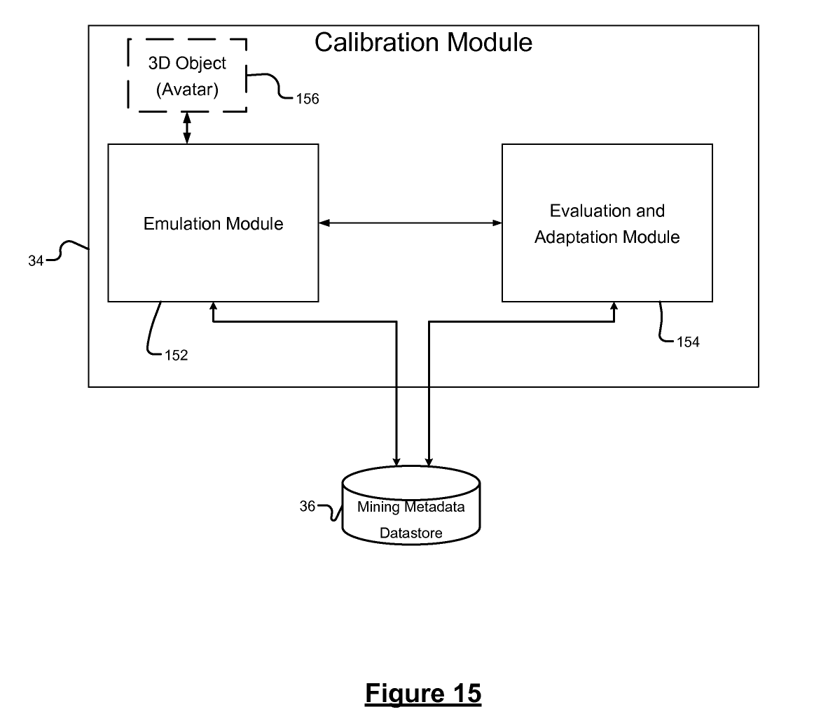

Once the processing module 32 has determined a transformation matrix, the transformation matrix can be calibrated by the calibration module 34. The calibration module 34 as shown in FIG. 15 comprises of an emulation module 152 and an evaluation and adaptation module 154.

The emulation module 152 is configured to generate a 3d object referred to as an avatar 156. The avatar 156 can be generated in advance and retrieved from a computer readable medium or may be generated in real time. The avatar 156 can have a known size and bounding box size. The avatar 156 is inserted into the image of the space at a predetermined location in the image. The image or merely the avatar 156 is converted using the transformation matrix determined by the processing module 32. According to one embodiment the transformation matrix for a particular cell is:

$$A = \vert \begin{matrix}{C}_{00} & {C}_{01} & {C}_{02} \\ {C}_{10} & {C}_{11} & {C}_{12} \\ {C}_{02} & {C}_{12} & {C}_{22}\end{matrix} \vert$$

In these embodiments, the avatar 156 should be placed in a single cell per calibration iteration. Each pixel in the cell in which the avatar 156 is located can be translated by calculating the following:

X=(x*C₀₀+y*C₀₁+C₀₂)/(x*C₂₀+y*C₂₁+C₃₂)

Y=(x*C₁₀+y*C₁₁+C₁₂)/(x*C₂₀+y*C₂₁+C₃₂)

where x and y are the coordinates on the first image to be translated and where X and Y are the coordinates of the translated pixels. It is appreciated that this may be performed for some or all of the pixels in the cell. Also for calibration purposes, each cell should be calibrated using its corresponding transformation matrix.

In the embodiments, the transformation matrix is defined as:

$$A = [ \begin{matrix}{R}_{11} & {R}_{12} & {R}_{13} & {t}_{1} \\ {R}_{21} & {R}_{22} & {R}_{23} & {t}_{2} \\ {R}_{31} & {R}_{32} & {R}_{33} & {t}_{2} \\ 0 & 0 & 0 & 1\end{matrix} ]$$

In these embodiments, the transformation can be performed using the following

$$λ [ \begin{matrix}x \\ y \\ 1\end{matrix} ] = [ \begin{matrix}{f}_{x} & 0 & {p}_{x} \\ & {f}_{y} & {p}_{y} \\ & & 1\end{matrix} ] [ \begin{matrix}1 & 0 & 0 & 0 \\ 0 & 1 & 0 & 0 \\ 0 & 0 & 1 & 0\end{matrix} ] [ \begin{matrix}{R}_{11} & {R}_{12} & {R}_{13} & {t}_{1} \\ {R}_{21} & {R}_{22} & {R}_{23} & {t}_{2} \\ {R}_{31} & {R}_{32} & {R}_{33} & {t}_{2} \\ 0 & 0 & 0 & 1\end{matrix} ] [ \begin{matrix}X \\ Y \\ Z \\ 1\end{matrix} ]$$

where x and y are the coordinates of a pixel to be transformed and X and Y are the coordinates of the transformed pixel. It is appreciated that the pixels are transformed by solving for X and Y.

Once the avatar 156 is transformed, the location of the transformed avatar 156 is communicated to the evaluation and adaptation module 154. The evaluation and adaptation module 154 receives the location of the originally placed avatar 156 with respect to the original space and the location of the transformed avatar 156 with respect to the transformed space. After transformation, the bounding box of the avatar 156 should remain the same size. Thus, the evaluation and adaptation module 154 will compare the bounding boxes of the original avatar 156 and the transformed avatar 156. If the transformed avatar 156 is smaller than the original avatar 156, then the evaluation and adaptation module 154 multiplies the transformation matrix by a scalar greater than 1. If the transformed avatar 156 is larger than the original avatar 156, than the evaluation and adaptation module 154 multiplies the transformation matrix by a scalar less than 1. If the two avatar 156 are substantially the same size, e.g. within 5% of one another, than the transformation matrix is deemed calibrated. It is appreciated that the emulation module 152 will receive the scaled transformation matrix and perform the transformation again. The emulation module 152 and the evaluation and adaptation module 154 may iteratively calibrate the matrix or matrices according to the process described above. Once the transformation matrix is calibrated it may be stored in the mined metadata data store 36 or may be communicated to the image and object transformation module 38.

Referring back to FIG. 1, the image and object transformation module 38 is used to transform the space observed in the FOV of the camera and monitored by the surveillance module 40. The image and object transformation module 38 receives an image and transforms the image using the transformation matrix or matrices. The transformed image is communicated to the surveillance module 40, such that the surveillance module 40 can observe the motion of motion objects in the transformed space. It is appreciated that by observing from the transformed space, the velocities and accelerations of the motion objects with respect to the space can be easily determined, as well as the geospatial locations of the motion objects.

When calibrating a camera, it may be useful to have one or more motion objects, e.g. a person or vehicle, move through the space observed in the FOV of the camera at a constant velocity. While it is not necessary, the motion data resulting from a constant velocity motion object may result in more accurate transformation matrices.

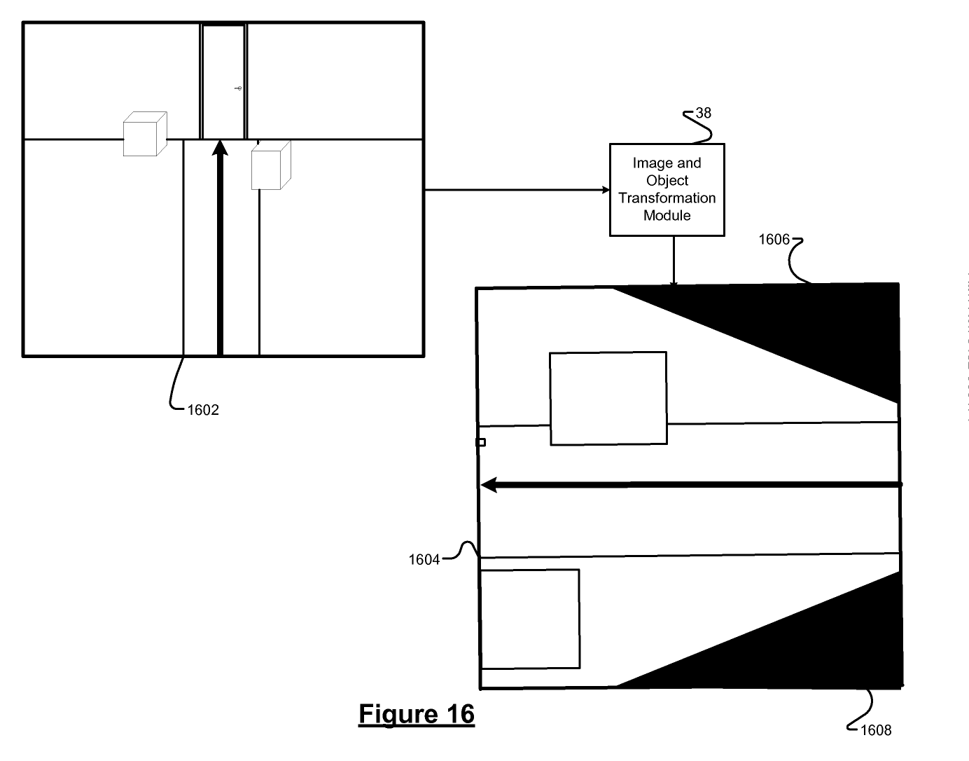

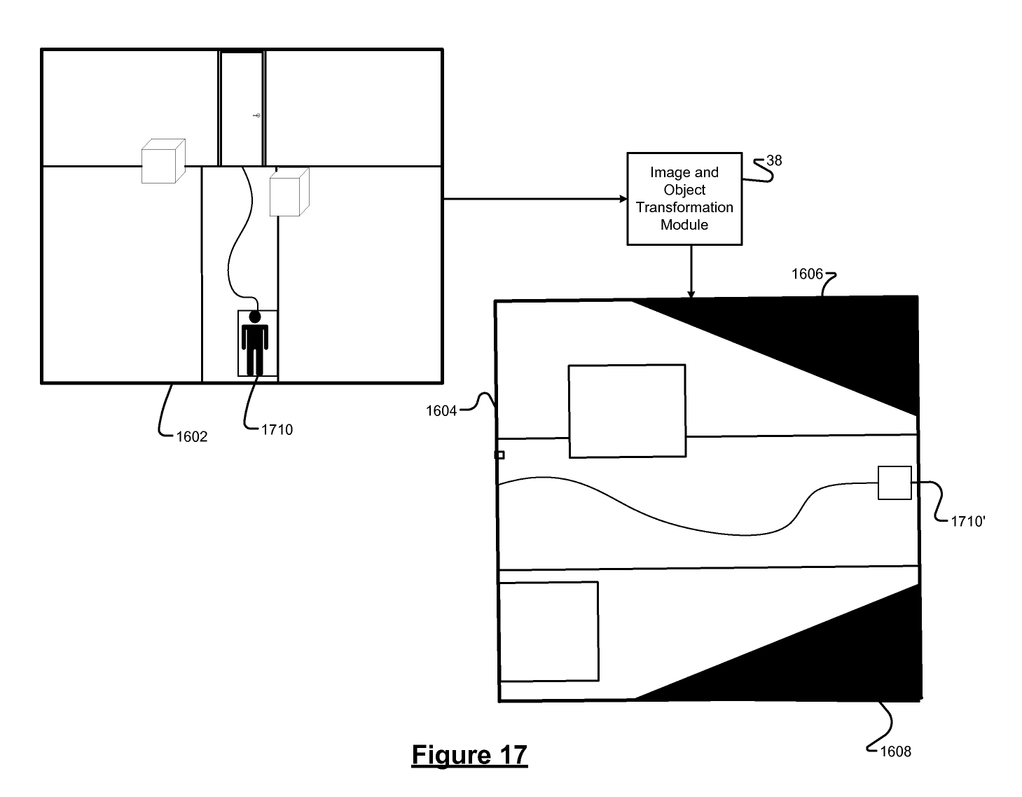

FIGS. 16 and 17 illustrate the results of the image and object transformation module 38. In FIG. 16 an image 1602 corresponding to an FOV from a camera having an unknown camera angle is observed. The image 1602 is passed to the image and object transformation module 38 which uses the determined transformation matrix to transform the image into a second image 1604. In this example, the second image has a birds-eye-view perspective that is derived from the first image. The dark regions 1606 and 1608 in the image correspond to sections in the observed space that were not in the FOV of the camera, but abut to areas that were close to the camera. FIG. 17 corresponds to FIG. 16. In FIG. 17, an avatar 1710 has been inserted into the image 1602. The image and object transformation module 1602 receives the image and transforms the object into the second image 1608. It is appreciated that the object in FIG. 17 could also be an observed image.

It is appreciated that by performing a transformation when monitoring a space, the observations by the surveillance module 40 will be greatly improved. For example, an actual velocity and acceleration of a motion object can be determined instead of a velocity or acceleration with respect to the field of view of the camera. Further, the geospatial locations of objects, stationary or moving, can be determined as well instead of the objects' locations with respect to the field of view of the camera.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for transforming data from a first image of a space to a second image of the space, the method comprising:
receiving image data from a video camera monitoring the space, wherein the video camera generates image data of an object moving through the space;
determining spatio-temporal locations of the object with respect to a field of view of the camera from the image data;
determining observed attributes of motion of the object in relation to the field of view of the camera based on the spatio-temporal locations of the object, the observed attributes including at least one of a velocity of the object with respect to the field of view of the camera and an acceleration of the object with respect to the field of view of the camera; and
determining the transformation matrix based on the observed attributes of the motion of the object.

2. The method of claim 1 further comprising transforming the first image of the space into the second image of the space.

3. The method of claim 2 further comprising calibrating the transformation matrix by
inserting a computer generated object into the first image;
transforming the computer generated object into a transformed object in the second image;
comparing the computer generated object and the transformed object; and
adjusting elements in the transformation matrix based on said comparing.

4. The method of claim 1 wherein said determining the transformation matrix is further based on actual attributes of motion with respect to the space, wherein the actual attributes of motion include a constant velocity with respect to the space of at least one of the object and another object.

5. The method of claim 1 wherein the field of view of the camera is divided into a plurality of cells.

6. The method of claim 5 wherein the spatio-temporal locations of the object are defined with respect to the plurality of cells.

7. The method of claim 6 further comprising generating a velocity map indicating a dominant flow direction of each cell of the plurality of cells and a cell velocity indicative of velocities of a plurality of observed objects in the cell moving in the dominant flow direction, wherein the cell velocity is defined with respect to the field of view of the camera and wherein the plurality of observed objects includes the object.

8. The method of claim 7 wherein said determining of the transformation matrix is based on the velocity map.

9. The method of claim 8 wherein said determining of the transformation matrix is further based on actual attributes of motion with respect to the space, wherein the actual attributes of motion include a constant velocity with respect to the space of at least one of the object and another object.

10. The method of claim 6 further comprising generating an acceleration map indicating a dominant flow direction of each cell of the plurality of cells and a cell acceleration indicative of accelerations of a plurality of observed objects in the cell moving in the dominant flow direction, wherein the cell acceleration is defined with respect to the field of view of the camera and wherein the plurality of observed objects includes the object.

11. The method of claim 10 wherein said determining of the transformation matrix is based on the acceleration map.

12. The method of claim 8 wherein said determining of the transformation matrix is further based on actual attributes of motion with respect to the space, wherein the actual attributes of motion include an acceleration having a value of zero, wherein the acceleration is with respect to the space and corresponds to at least one of the object and another object.

13. The method of claim 3 wherein said calibrating is performed iteratively.

14. A system for transforming data from a first image of a space to a second image of the space, the system comprising:
a metadata processing module configured to receive image data from a video camera monitoring the space, wherein the video camera generates image data of an object moving through the space and to determine spatio-temporal locations of the object with respect to a field of view of the camera from the image data;
a processing module configured to determine observed attributes of motion of the object in relation to the field of view of the camera based on the spatio-temporal locations of the object, the observed attributes including at least one of a velocity of the object with respect to the field of view of the camera and an acceleration of the object with respect to the field of view of the camera; and
a transformation module configured to determine the transformation matrix based on the observed attributes of the motion of the object.

15. The system of claim 14 wherein the transformation module is further configured to transform the first image of the space into the second image of the space.

16. The system of claim 15 further comprising a calibration module configured to
insert a computer generated object into the first image;
transform the computer generated object into a transformed object in the second image;
compare the computer generated object and the transformed object; and
adjusting elements in the transformation matrix based on said comparison.

17. The system of claim 14 wherein the transformation matrix is further based on actual attributes of motion with respect to the space, wherein the actual attributes of motion include a constant velocity with respect to the space of at least one of the object and another object.

18. The system of claim 14 wherein the field of view of the camera is divided into a plurality of cells.

19. The system of claim 18 wherein the spatio-temporal locations of the object are defined with respect to the plurality of cells.

20. The system of claim 19 further comprising a data fusion module configured to generate a velocity map indicating a dominant flow direction of each cell of the plurality of cells and a cell velocity indicative of velocities of a plurality of observed objects in the cell moving in the dominant flow direction, wherein the cell velocity is defined with respect to the field of view of the camera and wherein the plurality of observed objects includes the object.

21. The system of claim 20 wherein said the transformation matrix is based on the velocity map.

22. The system of claim 21 wherein said the transformation matrix is further based on actual attributes of motion with respect to the space, wherein the actual attributes of motion include a constant velocity with respect to the space of at least one of the object and another object.

23. The system of claim 19 further comprising a data fusion module that generates an acceleration map indicating a dominant flow direction of each cell of the plurality of cells and a cell acceleration indicative of accelerations of a plurality of observed objects in the cell moving in the dominant flow direction, wherein the cell acceleration is defined with respect to the field of view of the camera and wherein the plurality of observed objects includes the object.

24. The system of claim 23 wherein said the transformation matrix is based on the acceleration map.

25. The system of claim 24 wherein said the transformation matrix is further based on actual attributes of motion with respect to the space, wherein the actual attributes of motion include an acceleration having a value of zero, wherein the acceleration is with respect to the space and corresponds to at least one of the object and another object.
